(19) United States
(12) Patent Application Publication
(10) Pub. No.: US 2003/0220966 A1
(43) Pub. Date: Nov. 27, 2003

(54) System and method for dynamic content dependent conflict resolution

(75) Inventors: Stefan Alfons Hepper, Tuebingen (DE); Lothar Merk, Weil i.Schoenbuch (DE); Thomas Klein, Boeblingen (DE); Holger Waterstrat, Steinenbronn (DE)

Correspondence Address: Marilyn Smith Dawkins, International Business Machines Corporation, Intellectual Property Law Department, 11400 Burnet Road, Austin, TX, 78758, US

(73) Assignee: International Business Machines Corporation, Armonk, NY (US)

(21) Appl. No.: 10/232,250

(22) Filed: Aug. 29, 2002

(30) Foreign Application Priority Data
May 24, 2002 (DE) 01130178.5

(51) Int. Cl. G06F 15/16

(52) U.S. Cl. 709/203

(57) ABSTRACT

System and method for dynamic content dependent conflict resolution The present invention discloses a synchronization frame work which is functionally separated from the synchronization engine (sync engine) and which provides a common interface to an extendible set of synchronization modules (sync modules) providing different conflict detection and resolution strategies as well as different content adaptations. The dynamic selection engine being part of the synchronization framework is automatically selecting the appropriate strategies based on information from the different data stores which may be accessed locally or remotely. The selection of the sync module is based on the content (semantic) of the data being synchronized, as well as on the preferences of the user, global system settings, the capabilities of the utilized device, and the constrains of the used communication (configuration and run time data).

### FIELD OF THE INVENTION

The present invention relates to a system and method for synchronization of data between different clients and more particular to a conflict detection and resolution mechanism in a client-server architecture.

### BACKGROUND OF THE INVENTION

The main object of synchronization is to merge two different data stores of two devices in a way that after synchronization both of them hold the same data. During this merge, conflicts can arise. Most of the time, those conflicts arise because the same dataset has been altered on both data stores, e.g. user changes a phone number on his Personal Digital Assistant address book while concurrently his secretary changes it on the company's address book installed at the company server.

Prior art of resolving conflicts like these is that, dependent on the settings of the program synchronizing the two data stores, either one or the other wins—and changes on the loosing data store are lost. Common customization options are that this strategy (server wins or client wins) can be defined for the complete synchronization session (in which more than one data store can be synchronized), on a data store basis, or on a record basis. The smallest entity in these schemes is a record (e.g. a complete address book entry). This means when a record consisting of two or more fields is altered in both data stores, but both data stores altered different fields (e.g. phone number and e-mail address), after synchronization one of the two changes is lost. A common workaround for this problem is to duplicate the records on both machines and leave it to the user to merge the data by hand and delete the obsolete one (and synchronize again).

Another common conflict is that the two data stores have different capabilities. For instance the phone book on a mobile phone holds only name and number but the address record stored on the company's server address book holds not only one, but several phone numbers (e.g. home, office, fax, pager, cell phone) for the same person. Currently the user either loses some of these numbers when synchronizing the company's address book to his mobile phone, getting only the one number type he configured to his preferences, or he ends up with more than one entry per person, having the same name but different numbers.

### PRIOR ART

Synchronization is often accomplished via a synchronization server. Many devices, e.g. portable devices like mobile phone, personal digital assistant, notebooks, use a synchronization server (sync server) for synchronizing their data. The synchronization can either store all data locally which is normally used by carriers (e.g. Yahoo) with high loads, or can directly access backend data stores like IBM DB2, Domino or Exchange. A communication adapter inside of the sync server handles incoming synchronization request from various clients. The sync server requests synchronization data from the backend data store and compares it with the data that has been sent by the client. Occurring conflicts between changes on the client and on the server-side are detected and resolved in the synchronization engine. Finally, updated data is sent back to the client and to the backend data store.

The conflict resolution mechanism of current synchronization solutions is integrated in the so called sync engine. This sync engine handles incoming synchronization requests as well as the process of conflict detection, conflict resolution, and final data propagation. A separation of the conflict resolution mechanism from the sync engine is not possible.

Current synchronization schemes are very simple in their design. In most situations it is not a real synchronization but more a replication. This means the data store from client 1 is copied to the data store 3 of the sync server 10. Any changes on 3 are lost. The second scenario is a real synchronization situation, where a sync engine checks which records on both data stores have changed since the last synchronization took place and afterwards transfers the changed records from data store 3 to device 1 or 2 and the changed records from data store B to A. If a conflict arises by both data stores modifying the same record one of three options is chosen.

The server wins option specifies that in conflict situations the record on the server is the master record that should be taken. All changes to the client are lost. Analog the client wins option makes the client the master. The third option duplicates these records on both data stores and lets the user, after synchronization is finished, merge them by hand and deleting the no longer needed duplicate and synchronize again. All configurable options are selected before a synchronization session begins. It is possible to select rules depending on the type of data store and user. However it is not possible to configure rules dependent on a record semantic (e.g. MIME type), on the type of device being synchronized (e.g. phone, relational

database, etc.) and on a records content (e.g. skip all email being send by John Doe or Skip all attachments larger than xx Kbytes).

U.S. Pat. No. 5,774,717 discloses a method for resolving file system conflicts between a client file system and a server file system after the client file system has been disconnected from the server file system. Changes of the client file system are replayed for application to the server file system. Conflicts between the proposed changes and the current state of the server file system are detected and actions conditioned on the conflict type are presented to a user for selection. User selection and conflict type are used to determine the conflict resolution to apply to the client data during application. All conflicts are resolved as they are detected. The resynchronization process is controllable by the user from a display panel that presents the replay status and allows user interaction to monitor and alter the replay of transactions.

U.S. Pat. No. 6,295,541 discloses system and methods for synchronizing two or more datasets. To achieve this, a reference dataset is used to store a super-set of the latest or most-recent data from all user datasets to provide a repository of information that is available all times. Further, to simplify use, an unified user interface is provided that allows a user to easily determine which of his datasets are currently to be synchronized and allows the user to conveniently alter the current settings to select one, two or more than two clients for synchronization.

Prior art systems which require user input for determining conflict solutions do not allow to configure rules dependent on a records semantic (e.g. it's MIME type), on the type of device being synchronized (e.g. phone, relational database, etc.) and on a records content (e.g. ‘skip all emails being send by John Doe’ or ‘Skip all attachments larger than xx Kbytes’).

It is therefore object of the present invention to provide a system and method for synchronization of data between various devices via a sync server using a conflict detection and resolution technique which avoids the disadvantages of the prior art systems.

This object is solved by the features of the independent claims. Further embodiments of the present invention are laid down in the dependent claims.

### DISCLOSURE OF THE INVENTION

The present invention discloses a synchronization frame work which is functionally separated from the sync engine and which)provides a common interface to an extendible set of synchronization modules (sync modules) providing different conflict detection and resolution strategies as well as different content adaptations. The dynamic selection engine being part of the synchronization framework is automatically selecting the appropriate strategies based on information from the different data stores which may be accessed locally or remotely. The selection of the sync module is based on the content (semantic) of the data being synchronized, as well as on the preferences of the user, global system settings, the capabilities of the utilized device, and the constraints of the used communication (configuration and run time data).

The present invention allows dynamic selection (at runtime) of the conflict detection and resolution strategy. This can be done on a per data type, per user or user group, or depending on the utilized device or available bandwidth, or simply on the user's personal settings. The selection of the conflict resolution strategy is based on the content (semantic) of the data being synchronized, as well as on the preferences of the user, global system settings, the capabilities of the utilized device, and the constraints of the used communication mechanism. Especially in the mobile world, where bandwidth and connections costs are depending on the location of the device (e.g. cheep and fast indoor using Blue tooth, cheep and slow in the users home town, medium priced and slow in the users home country, and expensive and slow in a foreign country), it is useful to have the ability to dynamically adjust the complexity (and therefore connection time) of the conflict resolution. Conflict detection and resolution strategy is encapsulated in sync modules, which can be added and removed at runtime of the system through the offered framework. These sync modules itself can be two-staged for solving the conflict in a data independent (fast, but coarse-grained) and a data dependent way (slow, but fine-grained). In an environment, where encoded data is synchronized, a special sync module can be used that is capable of encoding and decoding the data for content dependent conflict detection and resolution. Such a sync module can be separated from the sync engine and instantiated at a special secured computer. The communication between sync server and conflict resolution modules can be done using Web services. Besides the ability to separate the conflict resolution of encrypted messages this mechanism allows to distribute the sync engine over the Intra- or Internet. This also enables the sync engine to deal with new or unknown data formats, as the sync engine can ask a UDDI directory (Universal Description, Discovery and Integration Project) for conflict resolution modules for that specific data type.

### BRIEF DESCRIPTION OF THE DRAWINGS

In the following a preferred embodiment of the present invention is described with reference to the drawings in which

FIG. 1 shows a prior art synchronization architecture,

FIG. 2 shows prior art synchronization architecture in which the conflict detection and resolution is part of the sync engine,

FIG. 3 shows the synchronization architecture having the inventive sync module framework,

FIG. 4 shows the internal architecture of the inventive sync module framework,

FIG. 5 shows the inventive synchronization process flow, and

FIG. 6 shows the process flow for selection of the suitable sync module(s).

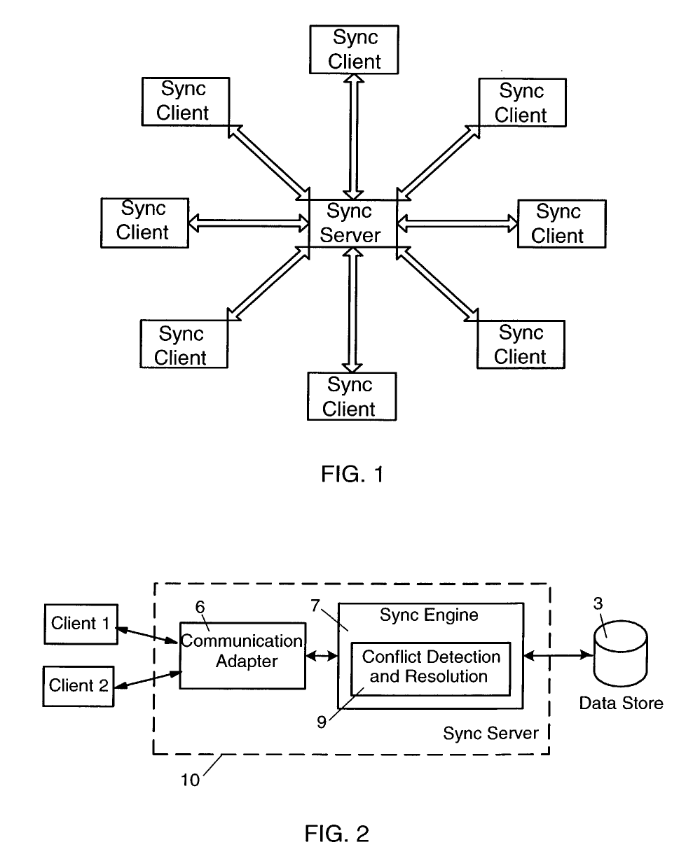

A widely used synchronization protocol is SyncML. SyncML provides an XML-based transport protocol for synchronization that is independent of the transport protocol. Each synchronization message is a XML-document. A typical SyncML system is shown in FIG. 2. Clients 1 and 2 which may be mobile clients (e.g. mobile phone or personal digital assistant) having a wired or wireless connection with a central sync server. Synchronization requests (updates or new entries) from the mobile clients are sent to the SyncEngine via the communication or SynML adapter 6. The communication adapter 6 or SynML adapter handles different incoming synchronization requests from client 1 and 2 and translates the requests into a data format supported by the central sync server 10. The sync engine 7 reads and writes synchronization requests directly to the backend data store 3. Communication between sync engine 7 and backend data store 3 can either be Java JDBC calls, ODBC calls, SOAP or HTTP requests or proprietary communication protocols. The backend data store 3 may be a relational database like Oracle or IBM DB2 or a non-relational data store like Microsoft Exchange or Lotus Domino. The backend data store 3 is connected with the central sync server 10 by Intranet or Internet. The conflict detection and resolution 9 is integrated in the sync engine 7. The sync engine 7 handles incoming synchronization requests as well as the process of conflict detection, conflict resolution, and final data propagation.

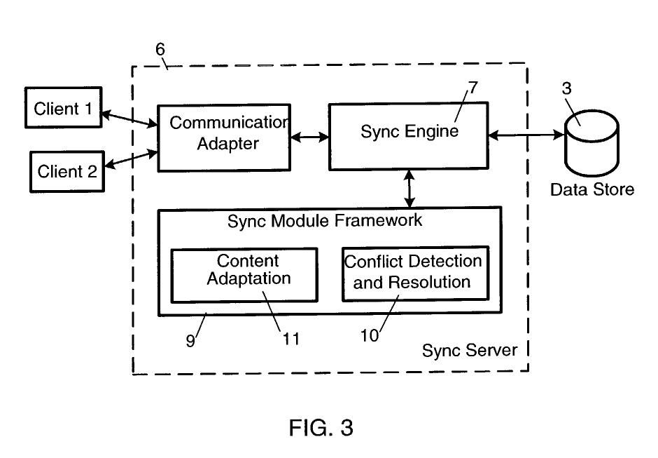

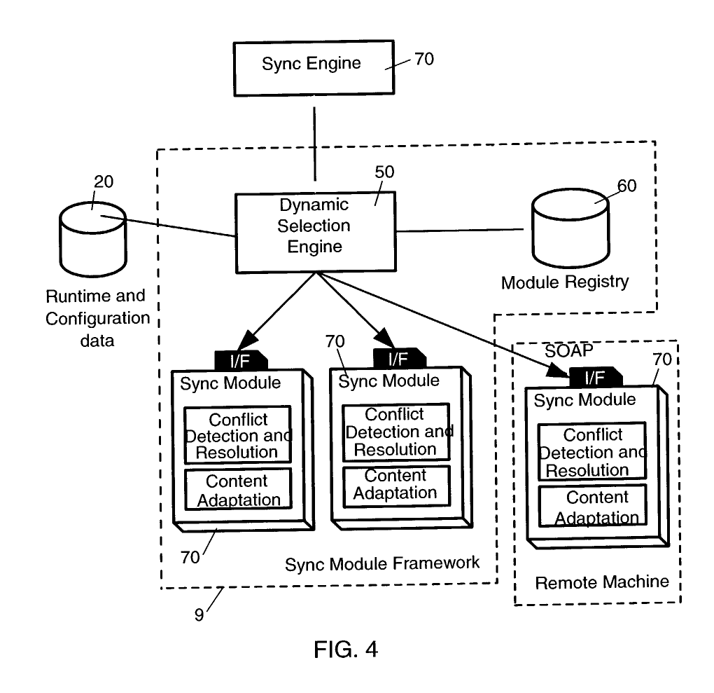

FIG. 3 shows the synchronization architecture with the basic inventive synchronization module framework 9. It is the basic implementation of the present invention to detach the conflict detection and resolution functionality 10 from the sync engine 7. This functionality is combined together with content adaptation methods 11 into a sync module framework 9. This framework 9 encapsulates the above-mentioned functionality in sync modules (see FIG. 4) which can be dynamically selected at runtime of the sync server 6.

FIG. 4 shows the internal structure of the sync module framework 9. For the provision of highly user and data dependent adaptation and resolution services, a dynamic selection engine 50 is part of the sync framework 9. The dynamic selection engine 50 has an interface to the sync engine 7 as well as a common interface to one or more different data stores 20, 60 which comprise system properties 20 (configuration data), user preferences 20 (configuration data), the module registry data 60, and the location and device information 20 (run time data). Those data stores can either be accessed locally, or remotely, or they can be fully integrated into the dynamic selection engine 50. The system properties data store 20 contains information on the Sync server environment, for example the default modules for certain data types or user role definitions. The user preferences data store 20 contains configuration information for each user. That information may comprise detailed rules for the selection of sync modules according to the occurring device, data type, and content. Or it only contains generic descriptions on which sync module is to use for which data type. Additionally, configuration information for specialized sync modules may be placed here, too. The sync module registry data store 60 holds information on the available sync modules 70, their capabilities, and how they can be accessed. For example, the information that belongs to a certain sync module 70 may comprise the IP-address of the server, where it can be accessed with SOAP (Simple Object Access Protocol), as well as the fact that it can handle contact and address data. Additionally, a generic description of the offered services could be added. This data store could for example be realized as UDDI directory (Universal Description, Discovery and Integration Project). The location and device data store 20 contains information about the ongoing synchronization of a user. That comprises the capabilities and type of the used device as well as the utilized communication channel. Additionally, information about the current location of the user can be stored for the provision of location based synchronization services. Like the module registry 60, this data store could also be realized as UDDI directory.

A sync module 70 encapsulates algorithms for conflict detection and resolution as well as for specialized content adaptation. The utilized algorithms can process synchronization requests in a fast and generic way, or they could offer content dependent and customizable conflict resolution as well as content adaptation. Each sync module 70 can be accessed over a well-defined interface especially a common interface, either locally on the same machine or remotely via Java RMI (Remote Method Invocation) or over a protocol like SOAP. A sync module may be registered with a description of its capabilities at the framework's module registry. The range of functionality that is offered by those sync modules 70 may be very broad. For example, there could be a sync module that offers conflict detection/resolution and customizable content adaptation for e-mail messages. Such a sync module can be configured to synchronize only personal messages (from friends or relatives) to all mobile devices of a user, while leaving all business e-mails unsynchronized on the server. Additionally, the sync module could adapt the e-mail messages that should be synchronized to the capabilities of the device. This would mean, that all attachments like files, or programs would be deleted from the e-mail to reduce the amount of memory that is needed to process and display the message. This sync module 70 would need information on the type and capabilities of the currently synchronizing device, which is stored by the sync server in the location and device data store 20. Additionally, customization information from the user is needed that describes, under which prerequisites an e-mail message should be synchronized to a mobile device like a cell phone or PDA. Such information is stored through an administration interface directly to the user preferences data store 20.

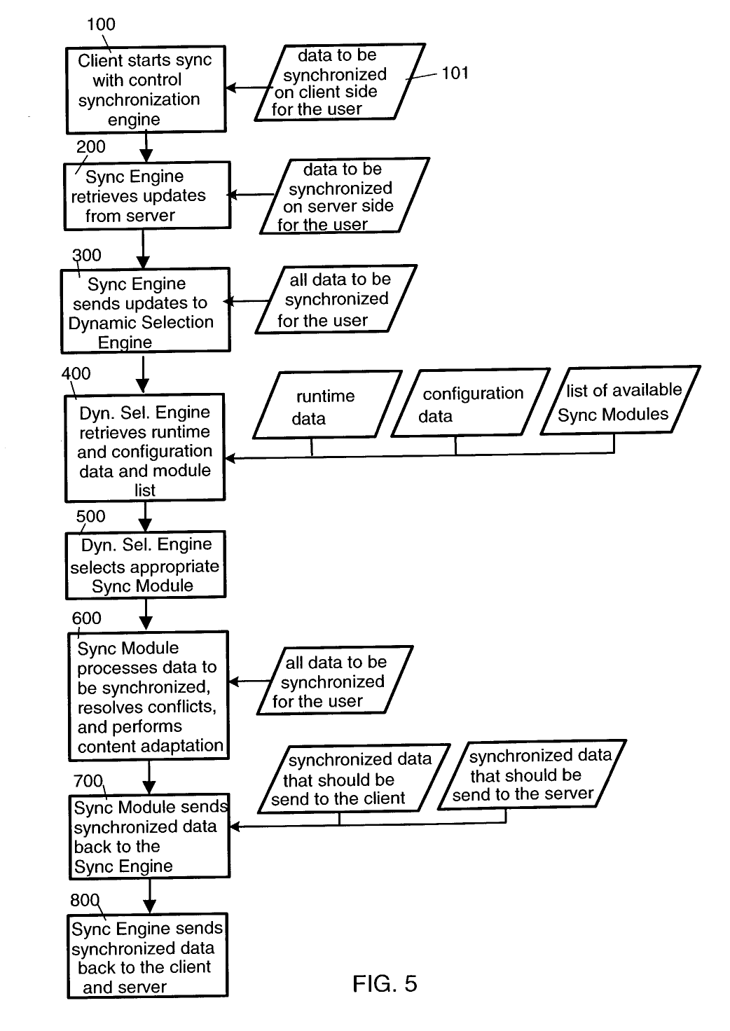

FIG. 5 gives an overview on the process flow that is performed during the synchronization between a client and a server using the sync module framework.

A user synchronizes e-mails and contacts from his address book between the company's central communication server and his PDA 100. The process of synchronization is initiated by the client device (i.e. the PDA) that contacts the sync server and sends its updated data 101. The client, e.g. mobile phone, requests a synchronization session with the synchronization server (sync server). Before the updates (data to be synchronized) can be sent to the central sync server an authentication between client and central sync server has to be accomplished. If the authentication is successful then central sync server accepts synchronization process and the client may send its updates. Each update record preferably contains a version number, a LUID, and data type of the updated data and the data to be updated. The central sync server receives the updates and then the LUID of each update is mapped with the mapping table containing LUIDs and their assigned server ID. If the LUID is not contained in the server mapping table the sync engine creates server ID and updates the mapping table with it. If the LUID is already contained in the mapping table the central sync engine replaces the LUID with the already existing server ID. After the mapping all client updates are buffered in the synchronization Server's volatile memory. Concurrently the corresponding updates from the synchronizing user provided by a backend data store are retrieved and buffered in the synchronization server's volatile memory 200. For retrieving the updates from the backend data store the sync engine requires information about the last successful synchronization from internal persistent client session information table. With this information all updates that have occurred since the last session can be retrieved from the backend end data store. After retrieval of all updates from the client 100 as well the backend side 200 during the client synchronization session the sync engine initiates a session with the synchronization module framework.

All updates buffered in synchronization server's volatile memory belonging to the specific client session are made accessible by dynamic selection engine 300. In the case that the synchronization server's volatile memory is not accessible directly by the dynamic selection engine all updates are sent to dynamic selection engine 300. The functionality of the dynamic selection engine is to provide access to updates collected by the sync server, collection of server configuration data and stored run time data, selection of the appropriate conflict strategy and finally the invocation of the sync module corresponding the selected strategy.

Configuration data (system properties, user preferences) comprises general setting for the sync server, e.g. default settings, session parameters (time outs) as well as user specific configuration data, e.g. user selections. Configuration data is either created by a system administrator by server system installation or by the client user through an exposed user configuration interface. Run time data (location and device information) comprises information on the synchronizing client devices, e.g. size of memory, supported protocols, supported data types, location and connection based information, e.g. bandwidth of the communication channel, the user's current location (outside, work at home). The run time data is created for each session by sync engine from data that has been exchanged during the client session initialization. Preferably the configuration data and run time data are stored in relational data base, e.g. IBM DB2 or Oracle. Furthermore, the dynamic selection engine has access to list of registered and available sync modules providing the conflict detection and strategies 400. The list comprises all sync modules that have been previously registered by a system administrator or have been made available by an access to Web Service registry (e.g. UDDI registry).

Now, the dynamic selection engine automatically collects information being part of the configuration and run time data 400. Those data are stored in relational data bases and the dynamic selection engine generates a data base query from the given frame work session information. The query is based on the user ID and the client synchronization session ID. Both information are retrieved by the dynamic selection engine during the frame work session initialization. The sync engine provides the user ID of client synchronization session, the session ID of synchronization session, and access to all buffered updates. The retrieved data from the data stores are buffered in volatile memory of the server system providing the dynamic selection engine.

Then, it retrieves the list of available sync modules from the module registry data store which may be accessed locally or remotely. The dynamic selection engine now accesses the updates buffered by the sync engine and retrieves the data type (e.g. MIME) of each update. Normally those data types are provided in the data record of the update provided by the client and backend. For each data type of the update a decision has to be taken which synchronization module should be invoked. The selection of the sync module used for processing synchronization and conflict resolution request can be based on different strategies. The following list shows commonly used selection strategies:

a selection based on the MIME type of the data (Multipurpose Internet Mail Extensions). A user may decide to fully synchronize all his calendar entries, but to leave his private e-mails on the server,

a selection based on user rights. Premium users that pay more for the offered services could utilize more sophisticated sync modules than standard users,

a selection based on user settings. There could be different sync modules for the same data type, for example a fast generic one and a slow per field conflict resolution sync module. A user could decide to use a fast (and maybe cheaper) sync module,

selection based on the utilized synchronization device. Mobile devices like phones or personal digital assistants (PDAs) are (in general) not able to offer the same display and storage functionality like desktop computers. Therefore, the synchronized data can be adopted to the specific requirements of the device through a sync module,

a selection based on the available bandwidth/communication cost as well as on the current location of the synchronizing user. In wireless computing environments, where connection time can be expensive, a special module can be chosen that reduces the data that is to be synchronized. For example, only the first 10 lines of every e-mail are synchronized, which reduces the connection time for the whole synchronization.

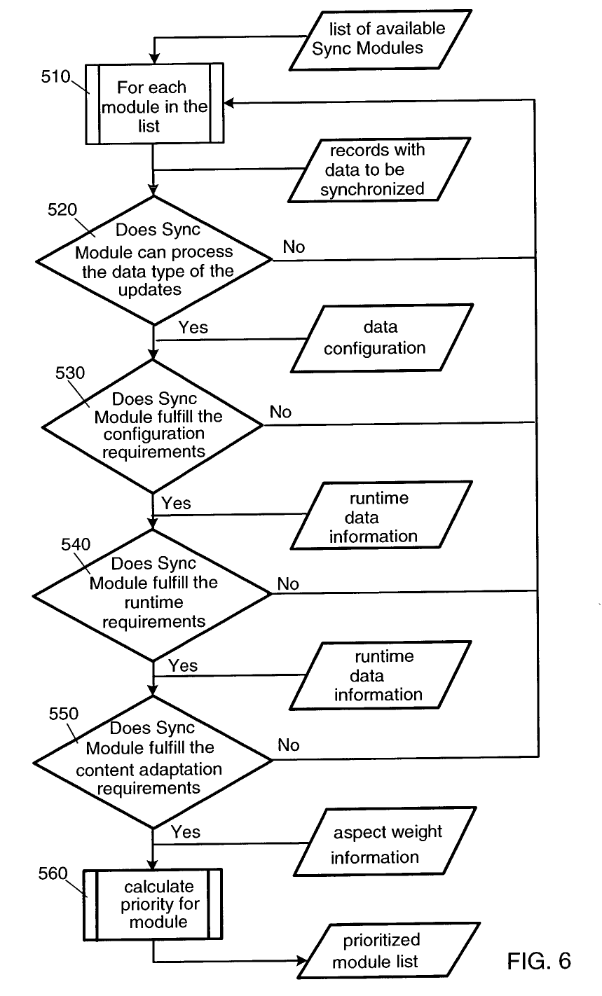

The selection decision of the sync module is illustrated in more detail by FIG. 6. That decision is based on data type of update record, the configuration data (default settings of the sync server and user defined information), and the run time data. The evaluation order is preferably based on following prioritized decision tree:

does the sync modules support the data type of the update record 520,

if yes, does the sync modules fulfill the requirements specified by configuration data 530,

if yes, does the remaining sync modules fulfill the requirements specified by the run time data 540

if yes, does the remaining sync modules fulfill the requirements of content adaptation imposed by the run data 550 (e.g. device capabilities, available bandwidth)

all remaining sync modules are prioritized based on non-technical aspects like usage costs, specialized sync modules having higher priority than generic sync modules, performance aspects faster have higher priority 560. A specific implementation could be that each aspect is weighted with a certain amount of points which is assigned to appropriate sync module. The final selection of the sync module to be used is based on its total amount of points calculated on above mentioned aspects. Eventually the user can redefine the default prioritization.

After the final decision of the sync module to be used for each data type the sync module is invoked through its commonly defined interface 500. All update records having the same data type are sent to selected sync module. The processing inside the sync module is adapted to specific data type and sync module characteristics. Nevertheless the following three steps are performed:

detection of occurred conflicts between client and server updates preferably based on the content of updated data itself (e.g. comparison of fields of two address book entries),

resolution of all detected conflicts by using the appropriate conflict strategy,

possibly adaptation of the content if required by the dynamic selection engine 600.

Afterwards the results are returned to dynamic selection engine and then to the synchronization engine 700. The results comprise all updates to the clients as well as all updates to the backend data store 800.

1. System for synchronization of data between different clients (1, 2) by using a central sync server (10) having a connection to said clients, wherein said clients having a program for creation of data to be synchronized and a program for establishing communication with the central sync engine of said central synchronization server, wherein said system is characterized by the further components:
data stores (20) providing configuration and run time data;
sync modules(70) providing different conflict detection and resolution strategies; and
dynamic selection engine (50) being functionally separated from said central sync engine(7) of said central sync server for automatically invoking a suitable sync module (70) based on said data from said data stores (20, 60).

2. System according to claim 1, wherein said dynamic selection engine (50) has a common interface to said sync engine (7).

3. System according to claim 1, wherein said sync engine (7) are locally or remotely accessible by said dynamic selection engine (50):

4. System according to claim 3, wherein said remotely located modules (70) are accessible via a SOAP-communication protocol.

5. System according to claim 1, wherein said sync module further comprising a content adaptation functionality.

6. System according to claim 1, further comprising a module registry (60) for providing information upon all available sync modules (70), wherein said module registry has an interface to said dynamic selection engine.

7. System according to claim 1, wherein said data stores (20, 60) have a common interface with said dynamic selection engine.

8. System according to claim 1, further comprising a backend data store wired connected with said central sync server for centralized storage of synchronized client's data.

9. System according to claim 1, wherein said client and said central sync server further comprising a communication adapter supporting the same communication protocol.

10. System according to claim 1, wherein said clients are mobile devices.

11. Method for synchronization of data between clients, comprising the steps of:
establishing a communication session between client and central sync server;
receiving data to be synchronized from said client containing a LUID, the data type of the data to be synchronized, and data to be synchronized;
mapping LUID of said data to be synchronized to an assigned server ID;
buffering said data to be synchronized in a volatile memory of said central sync server;
retrieving previously synchronized data from said data store;
establishing a communication session with said dynamic selection engine;
providing access to the buffered data for the dynamic selection engine;
retrieving configuration and run time data from said data store based on data derived during session initialization between sync engine and dynamic selection engine;
providing a list of accessible sync modules;
selecting the most suitable sync module based on the capabilities of each sync module and a given priority list;
invoking the sync module being selected and giving access to the data to be synchronized;
detecting and resolving conflicts between data to be synchronized;
returning the synchronized data to the central sync engine; and
distributing said synchronized data to the synchronizing client and said data store.

12. Method according to claim 11, further comprising the steps: adapting the content of the data to be synchronized based on run time data.

13. Method according claim 12, wherein said selecting step for most suitable synchronization module comprises the further steps of:
evaluation synchronization module supporting the data type of the data to be synchronized;
evaluation of the configuration data to be supported by the synchronization module;
evaluation of the run time data to be supported by the synchronization module;
evaluation of the content adaptation capabilities of synchronization module; and
selecting the final synchronization module based on a given priority list.

14. Method according to claim 13, wherein said priority list is based on cost and/or performance aspects.

15. Method according to claim 14, wherein said cost and/or performance aspects are weighted with an assigned amount of points which is assigned to appropriate sync engine and the final selection of a sync module is based on its total amount of points.

16. Computer program product stored in the internal memory of a digital computer, containing parts of software code to execute the method of:
establishing a communication session between client and central sync server;
receiving data to be synchronized from said client containing a LUID, the data type of the data to be synchronized, and data to be synchronized;
mapping LUID of said data to be synchronized to an assigned server ID;
buffering said data to be synchronized in a volatile memory of said central sync server;
retrieving previously synchronized data from said data store;
establishing a communication session with said dynamic selection engine;
providing access to the buffered data for the dynamic selection engine;
retrieving configuration and run time data from said data store based on data derived during session initialization between sync engine and dynamic selection engine;
providing a list of accessible sync modules;
selecting the most suitable sync module based on the capabilities of each sync module and a given priority list;
invoking the sync module being selected and giving access to the data to be synchronized;
detecting and resolving conflicts between data to be synchronized;
returning the synchronized data to the central sync engine; and
distributing said synchronized data to the synchronizing client and said data store.
